(19) United States
(12) Patent Application Publication
(10) Pub. No.: US 2026/0259812 A1
(43) Pub. Date: Sep. 3, 2026

(54) DISTRIBUTED TRACE PROCESSING WITH PARTIAL DEPTH-FIRST SEARCH HANDOFF FOR MONITORING LATENCY OF DISTRIBUTED SYSTEMS

(71) Applicant: Bloomberg Finance L.P., New York, NY (US)

(72) Inventor: Kusha MAHARSHI, New York, NY (US)

(73) Assignee: Bloomberg Finance L.P., New York, NY (US)

(21) Appl. No.: 19/684,787

(22) Filed: May 21, 2026

(51) Int. Cl. G06F 11/34; G06F 16/27

(52) U.S. Cl. CPC G06F 11/3419; G06F 11/3466; G06F 16/278; G06F 2201/80

(57) ABSTRACT

Systems and methods for determining a latency between a first span and a second span of a trace of a system are provided. A database comprising a plurality of partitions storing a plurality of spans of a trace of a request traversing through a system is maintained. One or more initial spans of the plurality of spans that are stored in the first partition are traversed by a first computation engine associated with a first partition of the plurality of partitions to extract latency information of the one or more initial spans. The one or more initial spans comprise a first span. In response to determining that a next span of the trace is not stored in the first partition, the latency information of the one or more initial spans is transmitted transmitting by the first computation engine to a second computation engine associated with a second partition of the plurality of partitions. One or more additional spans of the plurality of spans that are stored in the second partition are traversed by the second computation engine to extract latency information of the one or more additional spans. The one or more additional spans comprise a second span. A latency between the first span and the second span is determined based on the latency information of the one or more initial spans and the latency information of the one or more additional spans. The latency between the first span and the second span is output.

### TECHNICAL FIELD

The present invention relates generally to distributed systems, and in particular to distributed trace processing with partial depth-first search handoff for monitoring latency of distributed systems.

### BACKGROUND

Modern software architectures often utilize high-throughput, low-latency distributed systems comprising numerous interconnected services that communicate with one another to process requests and deliver functionality to end users. In such architectures, a single user request may traverse multiple services, each performing distinct operations, before a final response is generated. Monitoring the latency in such distributed systems is important for evaluating the user experience, identifying performance bottlenecks, establishing service level objectives, and informing system design decisions.

### BRIEF SUMMARY OF THE INVENTION

In accordance with one or more embodiments, systems and methods for determining a latency between a first span and a second span of a trace of a system are provided. A database comprising a plurality of partitions storing a plurality of spans of a trace of a request traversing through a system is maintained. One or more initial spans of the plurality of spans that are stored in the first partition are traversed by a first computation engine associated with a first partition of the plurality of partitions to extract latency information of the one or more initial spans. The one or more initial spans comprise a first span. In response to determining that a next span of the trace is not stored in the first partition, the latency information of the one or more initial spans is transmitted by the first computation engine to a second computation engine associated with a second partition of the plurality of partitions. One or more additional spans of the plurality of spans that are stored in the second partition are traversed by the second computation engine to extract latency information of the one or more additional spans. The one or more additional spans comprise a second span. A latency between the first span and the second span is determined based on the latency information of the one or more initial spans and the latency information of the one or more additional spans. The latency between the first span and the second span is output.

In one embodiment, the latency information of the one or more initial spans is stored by the first computation engine in a distributed messaging system. The latency information of the one or more initial spans is retrieved by the second computation engine from the distributed messaging system.

In one embodiment, the distributed messaging system is partitioned by trace identifier of the one or more additional spans.

In one embodiment, the latency information comprises a timestamp of the first span, a rule defining that the latency is to be determined between the first span and the second span, and a trace identifier and span identifier of the next span.

In one embodiment, the database comprises a distributed messaging system.

In one embodiment, the database comprises the plurality of partitions partitioned by trace identifier.

In one embodiment, a depth-first search is performed on the one or more initial spans and a depth-first search is performed on the one or more additional spans.

In one embodiment, the first computation engine does not have access to the second partition.

In one embodiment, in response to determining that another next span of the one or more additional spans is not stored in the second partition, the transmitting and the traversing of the one or more additional spans are repeated for one or more iterations using the second partition as the first partition, the second computation engine as the first computation engine, an additional partition as the second partition, an additional computation engine as the second computation engine, and one or more further spans of the trace as the one or more additional spans.

These and other advantages of the invention will be apparent to those of ordinary skill in the art by reference to the following detailed description and the accompanying drawings.

### BRIEF DESCRIPTION OF THE DRAWINGS

FIG. 1 shows an exemplary distributed system of an ordering system, for which embodiments of the invention may be implemented;

FIG. 2 shows an exemplary flow diagram of traces traversing through a distributed system, in accordance with one or more embodiments;

FIG. 3 shows a graph representing traces of a request traversing through a distributed system, in accordance with one or more embodiments;

FIG. 4 shows a technical architecture for determining latency in a distributed system, in accordance with one or more embodiments;

FIG. 5 shows a method for determining latency in a system, in accordance with one or more embodiments;

FIG. 6 shows a workflow for determining latency in a system, in accordance with one or more embodiments; and

FIG. 7 shows a high-level block diagram of a computer that may be used to implement one or more embodiments.

### DETAILED DESCRIPTION

Monitoring end-to-end latency of the workflow in distributed systems is important for evaluating the user experience, identifying performance bottlenecks, establishing service level objectives, informing system design decisions, and preventing incidents that can disrupt crucial infrastructure by enabling quick diagnosis. Monitoring latency in distributed systems may involve distributed tracing, where each request flow is represented as a trace, with individual operations within the trace represented as spans. Spans are received from numerous services of the distributed systems and stored in a distributed messaging system, where the spans are partitioned by trace identifier into a plurality of partitions of the distributed messaging system to enable parallel processing of spans to compute latency.

Traces in distributed systems often exhibit complex relationships known as fan-in relationships, where spans of a trace are linked together but partitioned into different partitions of the distributed messaging system for processing by different computation engines. However, a computation engine assigned to process spans stored in one partition typically does not have access to spans stored in other partitions, preventing that computation engine from traversing across the linked traces to compute end-to-end latency.

Conventional, state-of-the-art approaches to handling such complex fan-in relationships at scale have various limitations. Some approaches attempt to aggregate all spans belonging to linked traces into the same partition before processing, but this can create load imbalance issues when certain partitions become disproportionately large. Other approaches rely on custom, per-component metrics or per-service solutions that track latency within individual subsystems, leading to duplicated effort, increased maintenance costs, and fragmented observability across the distributed system. General-purpose observability tools have documented difficulties in handling fan-in trace structures while simultaneously supporting large-scale processing and flexible workflow definitions that can span arbitrary start and end points within a distributed system. Such general-purpose observability tools are typically limited to monitoring predefined, static start and end points, and are unable to monitor arbitrary start and end points within a distributed system.

Embodiments of the invention address the technical challenges of monitoring end-to-end latency of distributed systems with complex fan-in relationships by performing a depth-first search whose execution is split into partial fragments that are handed off between computation engines via a distributed messaging system. Advantageously, embodiments of the invention overcome the technical challenges associated with complex fan-in relationships to more efficiently and accurately measure end-to-end latency in large scale, high-throughput distributed systems, while avoiding load balancing, duplicated effort, increased maintenance costs, and fragmentation issues existing in conventional, state-of-the-art approaches.

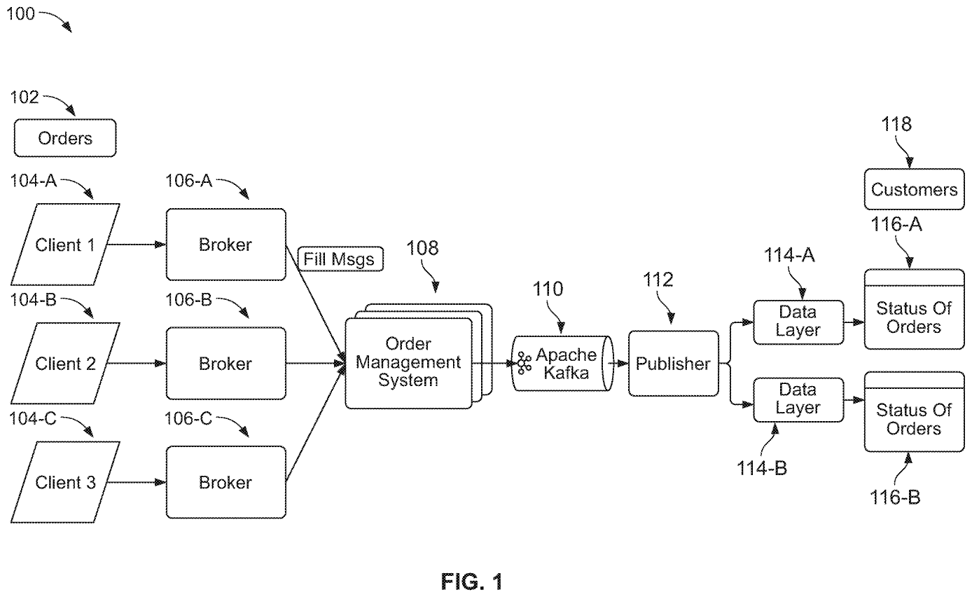

A distributed system is a collection of independent computing services (nodes) that work together to perform one or more tasks. Distributed systems underpin many modern software architectures, such as, e.g., content delivery networks, social media platforms, search engines, cloud platforms, telecommunications, blockchain, e-commerce, financial services, etc. An exemplary distributed system is shown in FIG. 1.

FIG. 1 shows an exemplary distributed system 100 of an ordering system, for which embodiments of the invention may be implemented. Distributed system 100 comprises the following services: brokers 106-A, 106-B, . . . , 106-C, order management system 108, Apache Kafka queue 110, publisher 112, and data layers 114-A and 114-B. In distributed system 100, clients 104-A, 104-B, . . . , 104-C submitted orders 102 to respective brokers 106-A, 106-B, . . . , 106-C, who transmit fill messages to order management system 108. The fill messages are written to a distributed messaging system (Apache Kafka queue 110), consumed in batches by publisher 112, and fanned out to data layers 114-A and 114-B for displaying the status of orders on a user interface 116-A and 116-B of customers 118. Distributed system 100 represents a single logical workflow that customers 118 are concerned with.

In distributed tracing, each request that flows through distributed system 100 is represented as a trace, with individual operations within the trace represented as spans. Spans are collected from numerous services in distributed system 100 and stored in a distributed messaging system (e.g., Apache Kafka queue 110). Spans are partitioned by trace identifier into different partitions of the distributed messaging system for processing by different computation engines to compute latency or other metrics.

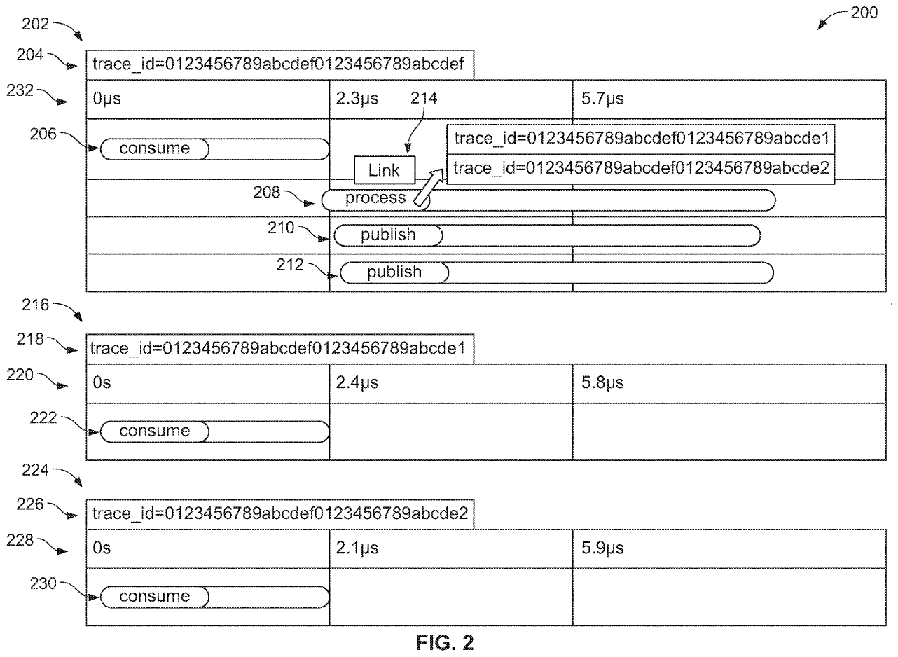

FIG. 2 shows an exemplary flow diagram 200 of traces traversing through a distributed system, in accordance with one or more embodiments. The traces shown in flow diagram 200 comprise spans representing operations (e.g., services, databases, APIs (application programming interfaces)) performed by Apache Kafka queue 110, publisher 112, and data layers 114-A and 114-B of distributed system 100 of FIG. 1.

As shown in flow diagram 200, trace 202 is assigned a trace identifier (trace_id) 204 of 0123456789abcdef0123456789abcdef and comprise the spans consume 206, process 208, publish 210, and publish 212 that execute at time 232. Trace 216 is assigned a trace identifier 218 of 0123456789abcdef0123456789abcde1 and comprises the span consume 222 that executes at time 220. Trace 224 is assigned a trace identifier 226 of 0123456789abcdef0123456789abcde2 and comprises the span consume 230 that executes at time 228.

Process 208 is linked 214 to two parent spans having different trace identifiers: 0123456789abcdef0123456789abcde1 (associated with trace 216) and 0123456789abcdef0123456789abcde2 (associated with trace 224). In operation, process 208 retrieves messages from Apache Kafka queue 110 in batches and processes the batches together. This results in different requests, having child spans referring to parent spans with different trace identifiers, being merged together. This complex relationship is referred to as a fan-in relationship.

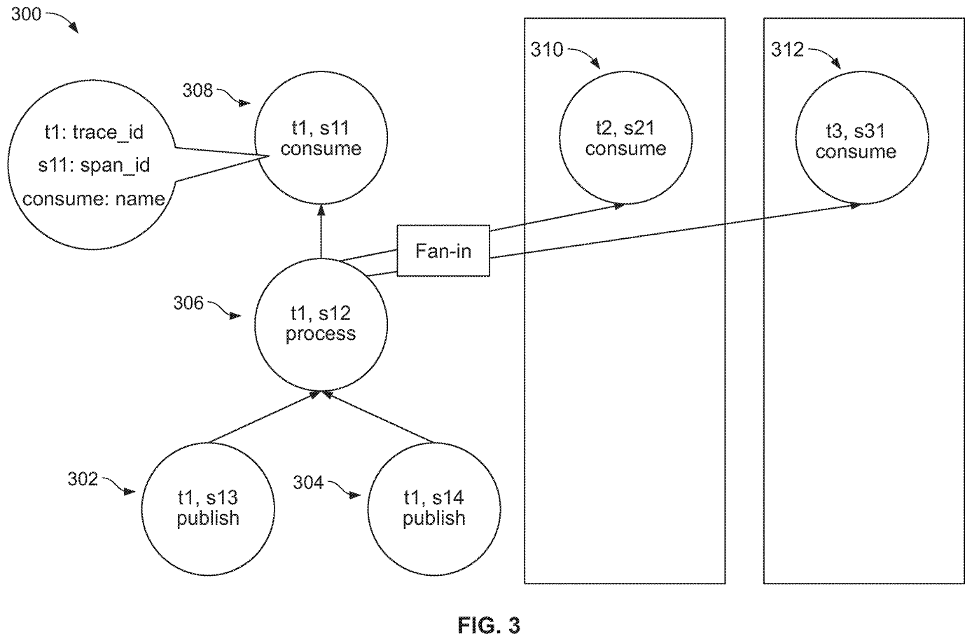

Traces may be represented as directed acyclic graphs (DAGs), where spans correspond to nodes and relationships between spans correspond to edges. FIG. 3 shows a graph 300 representing traces of a request traversing through a distributed system, in accordance with one or more embodiments. The directionality of graph 300 is shown with nodes 302-312 depicted from end span to start span, since each span comprises data identifying its parent span. Each node 302-312 is identified by, for example, trace identifier, span identifier, and name.

Graph 300 comprises node 302 corresponding to publish 210 having trace identifier t1 and span identifier s13 and node 304 corresponding to publish 212 having trace identifier t1 and span identifier s14. Nodes 302 and 304 have parent node 306 corresponding to process 208 having trace identifier t1 and span identifier s12. Node 306 has parent node 308 corresponding to consume 206 having trace identifier t1 and span identifier s11, parent node 310 corresponding to consume 222 having trace identifier t2 and span identifier s21, and parent node 312 corresponding to consume 230 having trace identifier t3 and span identifier s31. Node 306 has parent nodes 308, 310, and 312 corresponding to spans in different traces and having different trace identifiers, resulting in a fan-in scenario due to batching.

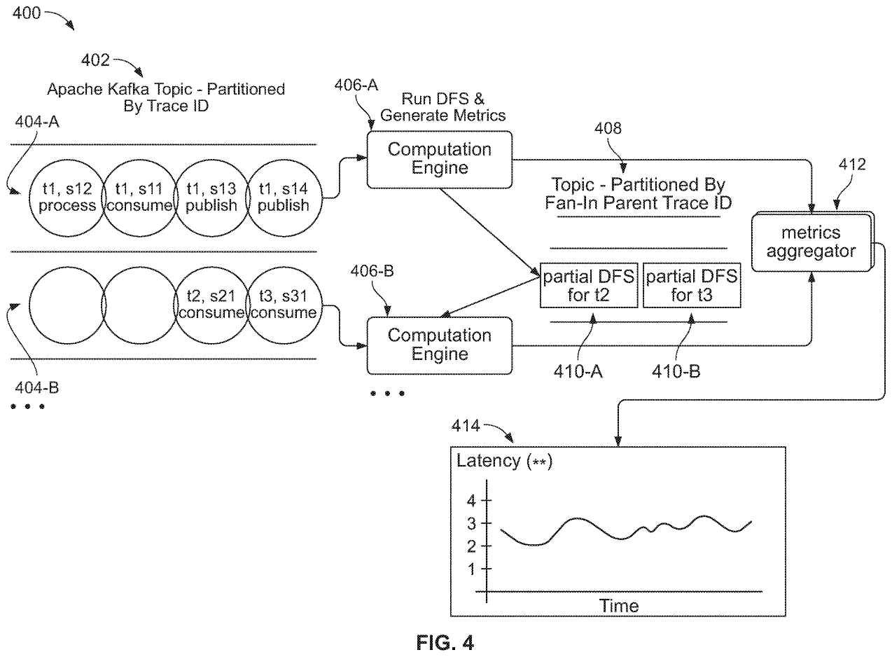

Embodiments of the invention address the technical challenges of complex fan-in relationships by performing a depth-first search whose execution is split into partial fragments that are handed off between computation engines via a distributed messaging system. FIG. 4 shows a technical architecture 400 for determining latency in a distributed system, in accordance with one or more embodiments. Requests flowing through the distributed system (e.g., distributed system 100 of FIG. 1) are represented as traces using distributed tracing, with individual operations within the trace represented as spans. Architecture 400 determines an end-to-end latency between a start span and end span. The start span and the end span may be defined according to a user-defined rule.

In architecture 400, a distributed messaging system 402 (e.g., Apache Kafka topic) is maintained having a first partition associated only with trace identifier t1 and a second partition associated only with trace identifiers t2 and t3. Accordingly, the first partition stores spans 404-A comprising a span for publish 212 having trace identifier t1 and span identifier s14, publish 210 having trace identifier t1 and span identifier s13, consume 206 having trace identifier t1 and span identifier s11, and process 208 having trace identifier t1 and span identifier s12. The second partition stores spans 404-B having a span for consume 230 having trace identifier t3 and span identifier s31 and consume 222 having trace identifier t2 and span identifier s21.

Computation engine 406-A is assigned to process spans 404-A (having trace identifier t1) stored in the first partition and computation engine 406-B is assigned to process spans 404-B (having trace identifiers t2 or t3) stored in the second partition. Accordingly, computation engine 406-A only has access to the first partition and computation engine 406-B only has access to the second partition.

Given, for example, a trace [publish (t1, s13), process (t1, s12), consume (t2, s21)] and a user-defined rule to determine the latency between consume (t2, s21) and publish (t1, s13), computation engine 406-A traverses spans 404-A by performing depth-first search (DFS) to extract latency information (e.g., start time and end time) for publish (t1, s13) and process (t1, s12). However, the next span in the trace, consume (t2, s21), is stored in the second partition, indicating a fan-in scenario. In response to determining that consume (t2, s21) is stored in the second partition which computation engine 406-A does not have access to, computation engine 406-A stores the latency information for publish (t1, s13) and process (t1, s12) to distributed messaging system 408 as partial DFS for t2 410-A. Computation engine 406-B retrieves partial DFS for t2 410-A and traverses spans 404-B by performing DFS to extract latency information for consume (t2, s21). Latency between consume (t2, s21) and publish (t1, s13) is calculated based on the latency information for publish (t1, s13), process (t1, s12), and consume (t2, s21), for example, as the difference between the timestamp of publish (t1, s13) and the timestamp of consume (t2, s21).

Similarly, given a trace [publish (t1, s13), process (t1, s12), consume (t3, s31)] and a user-defined rule to determine the latency between consume (t3, s31) and publish (t1, s13), computation engine 406-A traverses spans 404-A by performing DFS to extract latency information (e.g., start time and end time) for publish (t1, s13) and process (t1, s12). In response to determining that consume (t3, s31) is stored in the second partition which computation engine 406-A does not have access to, computation engine 406-A stores that latency information for publish (t1, s13) and process (t1, s12) to distributed messaging system 408 as partial DFS for t3 410-B. Computation engine 406-B retrieves partial DFS for t3 410-B and traverses spans 404-B by performing DFS to extract latency information for consume (t3, s31). Latency between consume (t3, s31) and publish (t1, s13) is calculated based on the latency information for publish (t1, s13), process (t1, s12), and consume (t3, s31), for example, as the difference between the timestamp of publish (t1, s13) and the timestamp of consume (t3, s31).

The latency determined by computation engine 406-A and 406-B are aggregated by metrics aggregator 412 to generate a final end-to-end latency 414 for the distributed system. While architecture 400 shows spans 404-A and 404-B stored in the first partition and the second partition for processing by computation engine 406-A and 406-B respectively, it should be understood that embodiments of the invention may be implemented for partial DFS handoff from any number of partitions and between any number of computation engines.

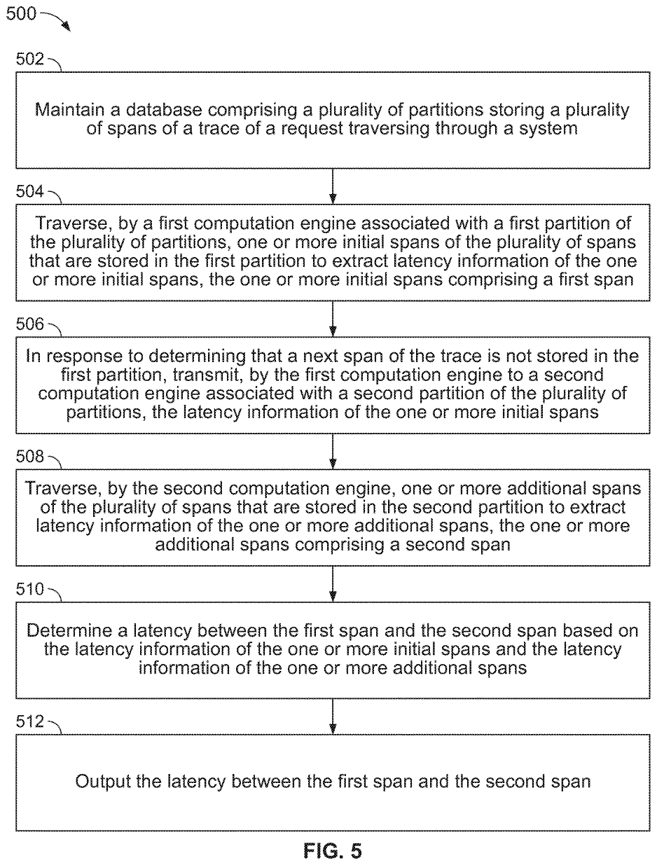

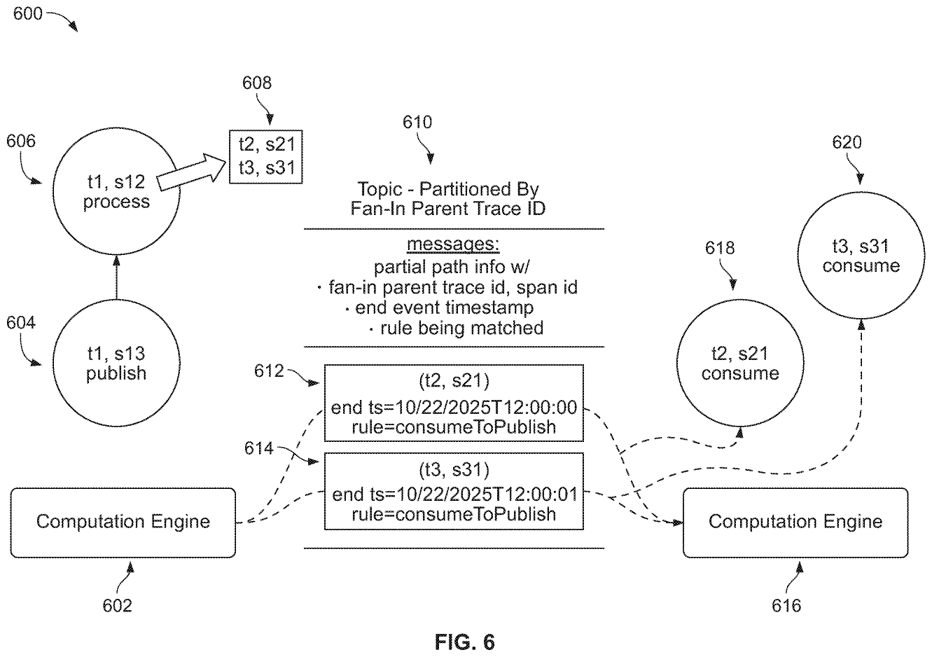

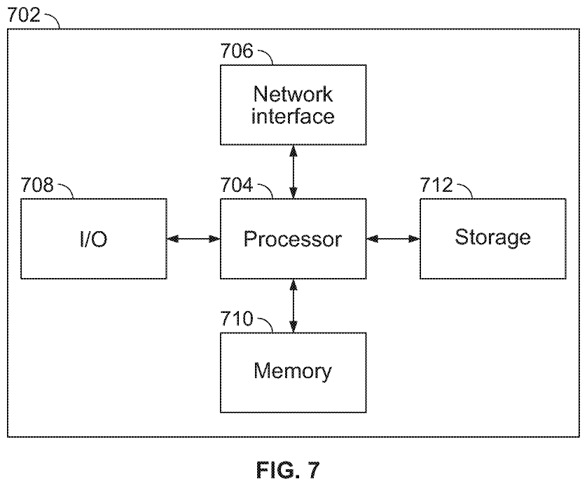

FIG. 5 shows a method 500 for determining latency in a system, in accordance with one or more embodiments. The steps and sub-steps of method 500 may be performed by one or more suitable computing devices, such as, e.g., computer 702 of FIG. 7. FIG. 6 shows a workflow 600 for determining latency in a system, in accordance with one or more embodiments. FIG. 3 and FIG. 4 will be described together.

At step 502 of FIG. 2, a database comprising a plurality of partitions storing a plurality of spans of a trace of a request traversing through a system is maintained. In one example, the plurality of spans include consume 206, process 208, publish 210, publish 212, consume 222, and consume 230 of FIG. 2. In another example, as shown in workflow 600 of FIG. 6, the plurality of spans is represented as node 604 (which corresponds to node 302 of FIG. 3), node 606 (which corresponds to node 306), node 618 (which corresponds to node 310), and node 620 (which corresponds to node 312).

The database may be any suitable database for storing the plurality of spans. In one embodiment, the database is a distributed messaging system that enables asynchronous communication between computation engines. Examples of distributed messaging systems include Apache Kafka, RabbitMQ, and Amazon SQS. The database may be partitioned by trace identifier or any other variable (e.g., by user, transaction, device, region, etc.). In this manner, each partition of the database may be associated with one or more, e.g., trace identifiers. For example, traces may be partitioned by hashing trace identifiers to partition numbers as follows: assigned_partition_number=trace_id % number_of_total_partitions. In this example, given 50 total traces and 5 total partitions, trace t0 would be stored in partition 0, trace t1 would be stored in partition 1, trace t2 would be stored in partition 2, . . . , trace t20 would be stored in partition 0, etc.

The plurality of spans may be generated via distributed tracing for tracing user requests traversing through services of the system (e.g., a distributed system). Each span is a data record comprising, e.g., operation name, start and end timestamps, span identifier, trace identifier, parent identifier identifying the identifier of its parent span, or any other suitable data (e.g., attributes or events). The plurality of spans may be received from various services of the system and stored and maintained in the database. For example, the database may be maintained by managing, securing, and/or optimizing the database to ensure performance, data integrity, and uptime. In other embodiment, the plurality of spans may additionally or alternatively be received from any other suitable database, e.g., by loading the plurality of spans from a storage or memory of a computer system (e.g., storage 712 or memory 710 of computer 702 of FIG. 7) or by receiving the plurality of spans from a remote computer system (e.g., computer 702 of FIG. 7).

In one embodiment, a user-defined rule may also be received at step 502 defining spans between which latency is to be determined. For example, the rule may be consumeToPublish, indicating that latency is to be determined from the consume span to the publish span. The rule may also define the latency as being determined based on a start or an end (or a custom) timestamp of the spans.

At step 504 of FIG. 5, one or more initial spans of the plurality of spans that are stored in a first partition of the plurality of partitions are traversed by a first computation engine associated with the first partition to extract latency information of the one or more initial spans. The one or more initial spans comprise a first span. In one example, as shown in workflow 600 of FIG. 6, the first computation engine is computation engine 602 traversing spans corresponding to nodes 604 and 606.

The first computation engine is assigned to consume and process spans in the first partition and does not have access to other partitions (e.g., the second partition). In one embodiment, the first computation engine traverses the one or more initial spans by performing a DFS. DFS traverses the one or more initial spans by diving as deep as possible into a trace to exhaust each branch before backtracking to the most recent parent and repeating the downward dive. While traversing the one or more initial spans, the first computation engine extracts latency information of the one or more initial spans. The latency information may include any information relevant for determining a latency for the user-defined rule. For example, the latency information may comprise the timestamp (the start and/or end timestamp) of the first span (e.g., node 604), the user-defined rule, and the trace identifier and span identifier of the fan-in parent span (the next span of the trace that is not stored in the first partition).

At step 506 of FIG. 5, in response to determining that the next span of the trace is not stored in the first partition, the latency information of the one or more initial spans is transmitted by the first computation engine to a second computation engine associated with a second partition of the plurality of partitions.

In one embodiment, the latency information is transmitted by the first computation engine to the second computation engine by storing the latency information in another database (e.g., another distributed messaging system). The other database is partitioned by fan-in parent trace identifier (e.g., the trace identifier of the next span) or any other variable. The second computation engine then retrieves the latency information. The latency information may be transmitted by the first computation engine to the second computation engine according to any other suitable approach (e.g., directly transmitting the latency information from the first computation engine to the second computation engine).

In one example, as shown in workflow 600 of FIG. 6, computation engine 602 traverses nodes 604 and 606 and determines that node 606 is linked 608 to nodes 618 and 620 that are stored in a different partition of the database than nodes 604 and 606 and associated with different trace identifiers. In response, computation engine 602 stores latency information 612 for the consume span corresponding to node 618 and latency information 614 for the consume span corresponding to node 620 in a partition of distributed messaging system 610. The partition of distributed messaging system 610 is associated with trace identifiers t2 and t3. Computation engine 616 then retrieves latency information 612 and 614.

At step 508 of FIG. 5, one or more additional spans of the plurality of spans that are stored in the second partition are traversed by the second computation engine to extract latency information of the one or more additional spans. The one or more additional spans comprise a second span. In one example, as shown in workflow 600 of FIG. 6, the first computation engine is computation engine 616 traversing spans corresponding to nodes 618 and 620.

The second computation engine is assigned to consume and process spans in the second partition and does not have access to other partitions (e.g., the first partition). In one embodiment, the second computation engine traverses the one or more additional spans by performing a DFS. While traversing the one or more additional spans, the second computation engine extracts latency information of the one or more additional spans, such as, e.g., the timestamp of the second span (e.g., node 618 or node 620). Accordingly, the second computation engine consumes the one or more additional spans from the second partition of the database as well as the latency information of the one or more initial spans stored in the partition of the other database.

At step 510 of FIG. 5, the latency between the first span and the second span is determined based on the latency information of the one or more initial spans and the latency information of the one or more additional spans. For example, the latency may be determined as the difference between the timestamp of the second span (in the latency information of the one or more additional spans) and the timestamp of the first span (in the latency information of the one or more initial spans).

At step 512 of FIG. 5, the latency between the first span and the second span is output. For example, the latency between the first span and the second span can be output by displaying the latency on a display device of a computer system (e.g., I/O 708 of computer 702 of FIG. 7), storing the results on a memory or storage of a computer system (e.g., memory 710 or storage 712 of computer 702 of FIG. 7), or by transmitting the results to a remote computer system (e.g., computer 702 of FIG. 7).

In one embodiment, method 500 may be repeated to determine latency for one or more additional traces of the system and the latencies may be aggregated to determine an end-to-end latency of the system.

In one embodiment, for example, where the second computation engine encounters another next span in the one or more additional spans that is not stored in the second partition (i.e., a fan-in scenario) at step 508, steps 506-508 may be iteratively repeated for each further span of the trance (stored in an additional partition of the database) using the second partition as the first partition, the second computation engine as the first computation engine, the additional partition as the second partition, an additional computation engine as the second computation engine, and the further spans as the one or more additional spans. In this manner, method 500 may be applied to determine the latency where there is any number of fan-in relationships in the trace.

Embodiments described herein may be applied to determine any metric of the system and are not limited to latency. For example, embodiments described herein may be applied to determine a count or success rate of a given workflow in the system. When an error occurs, span corresponding to the occurrence of the error are tagged with an attribute indicating the error. In accordance with method 500, the spans may be traversed to identify a frequency of spans where an error occurred. At step 510, instead of determining the latency, the success rate of the workflow can be determined as, e.g., the ratio of the frequency of spans where the error occurred to the total number of spans. Other metrics may be similarly determined in accordance with various embodiments of the invention.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatuses, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatuses, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps or functions of the methods and workflows described herein, including one or more of the steps or functions of FIGS. 1-6. Certain steps or functions of the methods and workflows described herein, including one or more of the steps or functions of FIGS. 1-6, may be performed by a server or by another processor in a network-based cloud-computing system. Certain steps or functions of the methods and workflows described herein, including one or more of the steps of FIGS. 1-6, may be performed by a client computer in a network-based cloud computing system. The steps or functions of the methods and workflows described herein, including one or more of the steps of FIGS. 1-6, may be performed by a server and/or by a client computer in a network-based cloud computing system, in any combination.

Systems, apparatuses, and methods described herein may be implemented using a computer program product tangibly embodied in an information carrier, e.g., in a non-transitory machine-readable storage device, for execution by a programmable processor; and the method and workflow steps described herein, including one or more of the steps or functions of FIGS. 1-6, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an example computer 702 that may be used to implement systems, apparatuses, and methods described herein is depicted in FIG. 7. Computer 702 includes a processor 704 operatively coupled to a data storage device 712 and a memory 710. Processor 704 controls the overall operation of computer 702 by executing computer program instructions that define such operations. The computer program instructions may be stored in data storage device 712, or other computer readable medium, and loaded into memory 710 when execution of the computer program instructions is desired. Thus, the method and workflow steps or functions of FIGS. 1-6 can be defined by the computer program instructions stored in memory 710 and/or data storage device 712 and controlled by processor 704 executing the computer program instructions. For example, the computer program instructions can be implemented as computer executable code programmed by one skilled in the art to perform the method and workflow steps or functions of FIGS. 1-6. Accordingly, by executing the computer program instructions, the processor 704 executes the method and workflow steps or functions of FIGS. 1-6. Computer 702 may also include one or more network interfaces 706 for communicating with other devices via a network. Computer 702 may also include one or more input/output devices 708 that enable user interaction with computer 702 (e.g., display, keyboard, mouse, speakers, buttons, etc.).

Processor 704 may include both general and special purpose microprocessors, and may be the sole processor or one of multiple processors of computer 702. Processor 704 may include one or more central processing units (CPUs), for example. Processor 704, data storage device 712, and/or memory 710 may include, be supplemented by, or incorporated in, one or more application-specific integrated circuits (ASICs) and/or one or more field programmable gate arrays (FPGAs).

Data storage device 712 and memory 710 each include a tangible non-transitory computer readable storage medium. Data storage device 712, and memory 710, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 708 may include peripherals, such as a printer, scanner, display screen, etc. For example, input/output devices 708 may include a display device such as a cathode ray tube (CRT) or liquid crystal display (LCD) monitor for displaying information to the user, a keyboard, and a pointing device such as a mouse or a trackball by which the user can provide input to computer 702.

Any or all of the systems, apparatuses, and methods discussed herein may be implemented using one or more computers such as computer 702.

One skilled in the art will recognize that an implementation of an actual computer or computer system may have other structures and may contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method comprising:
maintaining a database comprising a plurality of partitions storing a plurality of spans of a trace of a request traversing through a system;
traversing, by a first computation engine associated with a first partition of the plurality of partitions, one or more initial spans of the plurality of spans that are stored in the first partition to extract latency information of the one or more initial spans, the one or more initial spans comprising a first span;
in response to determining that a next span of the trace is not stored in the first partition, transmitting, by the first computation engine to a second computation engine associated with a second partition of the plurality of partitions, the latency information of the one or more initial spans;
traversing, by the second computation engine, one or more additional spans of the plurality of spans that are stored in the second partition to extract latency information of the one or more additional spans, the one or more additional spans comprising a second span;
determining a latency between the first span and the second span based on the latency information of the one or more initial spans and the latency information of the one or more additional spans; and
outputting the latency between the first span and the second span.

2. The computer-implemented method of claim 1, wherein transmitting, by the first computation engine to a second computation engine associated with a second partition of the plurality of partitions, the latency information of the one or more initial spans comprises:
storing, by the first computation engine, the latency information of the one or more initial spans in a distributed messaging system; and
retrieving, by the second computation engine, the latency information of the one or more initial spans from the distributed messaging system.

3. The computer-implemented method of claim 2, wherein the distributed messaging system is partitioned by trace identifier of the one or more additional spans.

4. The computer-implemented method of claim 1, wherein the latency information comprises a timestamp of the first span, a rule defining that the latency is to be determined between the first span and the second span, and a trace identifier and span identifier of the next span.

5. The computer-implemented method of claim 1, wherein the database comprises a distributed messaging system.

6. The computer-implemented method of claim 1, wherein the database comprises the plurality of partitions partitioned by trace identifier.

7. The computer-implemented method of claim 1, wherein
traversing, by a first computation engine associated with a first partition of the plurality of partitions, one or more initial spans comprises performing a depth-first search on the one or more initial spans; and
traversing, by the second computation engine, one or more additional spans comprises performing a depth-first search on the one or more additional spans.

8. The computer-implemented method of claim 1, wherein the first computation engine does not have access to the second partition.

9. The computer-implemented method of claim 1, further comprising:
in response to determining that a further span of the trace is not stored in the second partition, repeating the transmitting and the traversing of the one or more additional spans for one or more iterations using the second partition as the first partition, the second computation engine as the first computation engine, an additional partition as the second partition, an additional computation engine as the second computation engine, and one or more further spans of the trace as the one or more additional spans.

10. An apparatus comprising:
a processor; and
a memory to store computer program instructions, the computer program instructions when executed on the processor cause the processor to perform operations comprising:
maintaining a database comprising a plurality of partitions storing a plurality of spans of a trace of a request traversing through a system;
traversing, by a first computation engine associated with a first partition of the plurality of partitions, one or more initial spans of the plurality of spans that are stored in the first partition to extract latency information of the one or more initial spans, the one or more initial spans comprising a first span;
in response to determining that a next span of the trace is not stored in the first partition, transmitting, by the first computation engine to a second computation engine associated with a second partition of the plurality of partitions, the latency information of the one or more initial spans;
traversing, by the second computation engine, one or more additional spans of the plurality of spans that are stored in the second partition to extract latency information of the one or more additional spans, the one or more additional spans comprising a second span;
determining a latency between the first span and the second span based on the latency information of the one or more initial spans and the latency information of the one or more additional spans; and
outputting the latency between the first span and the second span.

11. The apparatus of claim 10, wherein transmitting, by the first computation engine to a second computation engine associated with a second partition of the plurality of partitions, the latency information of the one or more initial spans comprises:
storing, by the first computation engine, the latency information of the one or more initial spans in a distributed messaging system; and
retrieving, by the second computation engine, the latency information of the one or more initial spans from the distributed messaging system.

12. The apparatus of claim 11, wherein the distributed messaging system is partitioned by trace identifier of the one or more additional spans.

13. The apparatus of claim 10, wherein the latency information comprises a timestamp of the first span, a rule defining that the latency is to be determined between the first span and the second span, and a trace identifier and span identifier of the next span.

14. The apparatus of claim 10, wherein the database comprises a distributed messaging system.

15. The apparatus of claim 10, wherein the database comprises the plurality of partitions partitioned by trace identifier.

16. The apparatus of claim 10, wherein
traversing, by a first computation engine associated with a first partition of the plurality of partitions, one or more initial spans comprises performing a depth-first search on the one or more initial spans; and
traversing, by the second computation engine, one or more additional spans comprises performing a depth-first search on the one or more additional spans.

17. The apparatus of claim 10, wherein the first computation engine does not have access to the second partition.

18. The apparatus of claim 10, the operations further comprising:
in response to determining that a further span of the trace is not stored in the second partition, repeating the transmitting and the traversing of the one or more additional spans for one or more iterations using the second partition as the first partition, the second computation engine as the first computation engine, an additional partition as the second partition, an additional computation engine as the second computation engine, and one or more further spans of the trace as the one or more additional spans.

19. A non-transitory computer-readable storage medium comprising instructions which, when executed by a computer, cause the computer to carry out operations comprising:
maintaining a database comprising a plurality of partitions storing a plurality of spans of a trace of a request traversing through a system;
traversing, by a first computation engine associated with a first partition of the plurality of partitions, one or more initial spans of the plurality of spans that are stored in the first partition to extract latency information of the one or more initial spans, the one or more initial spans comprising a first span;
in response to determining that a next span of the trace is not stored in the first partition, transmitting, by the first computation engine to a second computation engine associated with a second partition of the plurality of partitions, the latency information of the one or more initial spans;
traversing, by the second computation engine, one or more additional spans of the plurality of spans that are stored in the second partition to extract latency information of the one or more additional spans, the one or more additional spans comprising a second span;
determining a latency between the first span and the second span based on the latency information of the one or more initial spans and the latency information of the one or more additional spans; and
outputting the latency between the first span and the second span.

20. The non-transitory computer-readable storage medium of claim 19, wherein transmitting, by the first computation engine to a second computation engine associated with a second partition of the plurality of partitions, the latency information of the one or more initial spans comprises:
storing, by the first computation engine, the latency information of the one or more initial spans in a distributed messaging system; and
retrieving, by the second computation engine, the latency information of the one or more initial spans from the distributed messaging system.

21. The non-transitory computer-readable storage medium of claim 20, wherein the distributed messaging system is partitioned by trace identifier of the one or more additional spans.

22. The non-transitory computer-readable storage medium of claim 19, wherein the latency information comprises a timestamp of the first span, a rule defining that the latency is to be determined between the first span and the second span, and a trace identifier and span identifier of the next span.

23. The non-transitory computer-readable storage medium of claim 19, wherein the database comprises a distributed messaging system.

24. The non-transitory computer-readable storage medium of claim 19, wherein the database comprises the plurality of partitions partitioned by trace identifier.

25. The non-transitory computer-readable storage medium of claim 19, wherein
traversing, by a first computation engine associated with a first partition of the plurality of partitions, one or more initial spans comprises performing a depth-first search on the one or more initial spans; and
traversing, by the second computation engine, one or more additional spans comprises performing a depth-first search on the one or more additional spans.

26. The non-transitory computer-readable storage medium of claim 19, wherein the first computation engine does not have access to the second partition.

27. The non-transitory computer-readable storage medium of claim 19, the operations further comprising:
in response to determining that a further span of the trace is not stored in the second partition, repeating the transmitting and the traversing of the one or more additional spans for one or more iterations using the second partition as the first partition, the second computation engine as the first computation engine, an additional partition as the second partition, an additional computation engine as the second computation engine, and one or more further spans of the trace as the one or more additional spans.
